(19) United States
(12) Patent Application Publication
(10) Pub. No.: US 2004/0207847 A1
(43) Pub. Date: Oct. 21, 2004

(54) Apparatus and methods for alignment of optical barrier apparatus

(76) Inventor: Joseph A. Hardy, Palm Harbor, FL (US)

Correspondence Address: Louis J. Franco, Law Office of Louis J. Franco, 250 Arbor Street, Lunenburg, MA, 01462, US

(21) Appl. No.: 10/418,394

(22) Filed: Apr. 18, 2003

(51) Int. Cl. G01B 11/00

(52) U.S. Cl. 356/399

(57) ABSTRACT

A method of optically aligning a permanent energy emitter with a first target includes steps to fix the attitude of the emitter retainer portion of an adjustable and selectively fixable emitter bracket as follows. An adjustable emitter bracket facilitative of the method includes (i) a base, (ii) an emitter retainer for selectively retaining an energy emitter and (ii) at least one set of adjustable and selectively fixable linkage members interconnecting the base and the emitter retainer. A temporary emitter is retained by the emitter retainer and caused to emit a detectable beam of electromagnetic energy. The bracket is manipulated and secured in a position in which the emitting beam impinges upon a target positioned such that, when the temporary emitter is replaced by the permanent emitter, energy emitting from the permanent emitter will impinge upon the first target. The temporary emitter is then replaced with the permanent emitter.

### STATEMENT OF UNITED STATES GOVERNMENT RIGHTS IN THE INVENTION

This invention was made with U.S. Government support under contract 512593-00-B-1036 awarded by the U.S. Postal Service. The U.S. Government has certain rights in this invention.

### BACKGROUND

1. Field

Although not so limited in its utility or scope, implementations of the present invention are particularly well suited for incorporation in material handling and sortation systems such as those used in moving mail pieces through various stages of processing in a mail processing facility, for example.

2. Brief Description of Illustrative Environments and Related Art

Optical barrier apparatus are widely employed as switches in various industries and even in some residential applications. The basic elements of optical barrier apparatus are an energy emitter and an energy detector or receiver. An emitter and detector are optically aligned such that energy emitted from the emitter, unless interrupted by the presence of an object along the intended optical path of the emitted energy, is detected by the detector. Incorporated within an electrical circuit, the detector acts as a switch having, in its most basic form, alternative “on” and “off” states, wherein one state represents the detection of energy and the other state represents the non-detection of energy. The energy emitted and detected is electromagnetic and may represent a single or multiple wavelengths within an energy band or wavelengths across multiple energy bands including, by way of non-limiting example, the deep-ultraviolet, ultraviolet, visible, near-infrared, mid-infrared and long-infrared energy bands. Today's optical barriers are typically opto-electronic linkages operating on the “by default” principle, the primary function of which is to continually testify to the integrity of a given optical path between the emitter and detector.

Common applications of optical barriers are observable in everyday life. For instance, many homes are equipped with automatic garage door openers that include an emitter-detector pair that is activated when the opener receives a signal to close the door. The emitter and detector are optically aligned across the door opening. When the command to close the door is received from either a hardwired control panel or a remote signal emitter, the energy emitted by the emitter optically aligned with the detector emits an electromagnetic signal and the detector is activated. If the emitted signal is not received by the detector, the door-closing operation is either prevented or, if already in progress when the energy beam is interrupted, ceased. In this context, the emitter-detector pair serves the safety function of preventing injury to persons or pets and damage to property by preventing the door from closing upon an object interrupting the energy beam by virtue of the object's being in the optical path between the emitter and the detector.

Another everyday application of optical barrier apparatus can be observed at nearly any grocery store checkout lane. When a patron places items upon the moving conveyor belt to transport them forward toward the checkout clerk, the forward motion of the conveyor is arrested whenever an item interrupts an energy beam directed across the conveyor belt in the proximity of the cash register. The circuitry of the conveyor system is arranged such that the non-receipt of the emitted energy by the detector optically aligned with the energy emitter serves as a signal to interrupt electric current to the motor that drives the conveyor.

Optical barrier apparatus are widely used as machine guards, conveyor batch counters, gate and door controls and intruder alarms in industrial environments such as assembly plants and large-scale material handling operations, for example. Material handling operations, such as mail-sorting facilities, frequently involve the use of transport systems including networks of conveyor belts, roller conveyors, conduits and chutes. Optical barriers, and more particularly the signals generated in response to the uninterrupted or interrupted status thereof, are used to automate various functions within a sorting facility including, for example, the starting and stopping of transport apparatus such as conveyor belts and power-roller conveyors and the movement of gates and deflectors to block and/or redirect package flow.

Regardless of the context in which optical barriers are employed, proper operation depends on the optical alignment of an emitter with at least one detector. “Optical alignment” may have different specific meanings in different circumstances. Generally, however, a detector is understood to be in optical alignment with an emitter when the emitter and detector are arranged such that energy of sufficient intensity originating from the emitter will be received by the detector in the absence of an obstruction. The photo emitter and detector may be in “direct” optical alignment or “indirect” optical alignment. The emitter and detector are in direct optical alignment when, for example, the detector lies along the optical axis, or within the cone of divergence, of the energy as emitted from its source. The emitter and detector are in “indirect” alignment when, for instance, the energy emitted from an emitter is refracted or reflected through or from one or more intermediate optical elements (e.g., a lens, mirror, prism, beam splitter or reflector) before impinging on the detector.

A transmission-type optical barrier is typically characterized by separate emission and detection terminals. Contrarily, a reflection-type optical barrier is frequently characterized by a signal unit that emits an energy ray and detects the emitted ray. Inclusion of the emitter and detector in the same unit provides the obvious advantage of having all the electronics in the same location. Reflection barriers rely upon the reflection of an energy ray back toward its source as the detector is typically adjacent the emitter. Accordingly, reflection barriers include one or more reflective elements (e,g, a mirror or reflector) from which the signal can reflect back toward the source. A retroreflector, or “retroflector,” may be used in place of a mirror. Retroflectors are preferable to mirrors because they are more tolerant of misalignment than mirrors. For instance, a typical retroflector sends a ray of light in a direction to its incident direction of travel with zero or near-zero deflection angles of incidence of +/−10° or more.

There exist circumstances in which large numbers of optical barriers are to be installed in a facility and in which “power off alignment” of optical barrier elements (e.g., emitters and detectors) is desirable. For instance, in at least some cases, installers of optical barriers mount brackets, emitters and detectors in their intended locations, but alignment is performed as a step subsequent to, or contemporaneous with, the hardwiring of the optical barrier elements. Moreover, the emitters involved frequently emit electromagnetic energy outside the visible range of the electromagnetic spectrum, such as infrared, for example, which also complicates alignment.

Accordingly, there exists a need for a method and associated apparatus that facilitates “power-off” alignment of optical barrier apparatus and, in some implementations, that employs a portable emitter that emits electromagnetic energy in the visible region and includes a self-contained power source.

### SUMMARY

In accordance with various implementations, a method of optically aligning an emitter of an optical barrier with a predetermined first target (e.g., a detector or sensor) includes the step of providing an emitter bracket including (i) a base adapted for mounting to a bracket-supporting structure, (ii) an emitter retainer adapted for selectively retaining an electromagnetic energy emitter and (iii) at least one set of adjustable and selectively fixable linkage members interconnecting the base and the emitter retainer such that the attitude of the emitter retainer with respect to the base is alternatively adjustable and fixable. In various embodiments, the emitter retainer is capable of alternative retention and release of an energy emitter without introducing an alignment-negating net change in the attitude of the emitter retainer. That is, once the attitude of the emitter retainer is set in a desired attitude, an emitter can be removed from the emitter-retainer and then reinstalled for retention by the emitter-retainer without introducing a net change in the attitude of the emitter retainer that would render the emitter misaligned with a target with which it has been previously aligned.

With the base of the emitter bracket secured to a bracket-supporting structure, an alignment method further includes the step of providing a temporary electromagnetic energy emitter having a self-contained power source such as an internally contained battery or an external, but portable battery, for example. Variations of the alignment method provide an energy emitter that emits collimated visible light such as laser light. Alternative versions emit collimated electromagnetic energy outside the visible region, non-collimated electromagnetic energy outside the visible region and non-collimated visible light. The temporary energy emitter is removably retained by the emitter retainer and caused to emit electromagnetic energy by, for example, closing a switch to complete an electrical circuit including the power source and the emitting element(s) of the temporary emitter.

With energy emitting from a temporary emitter retained by the emitter retainer, an individual adjusts the bracket with respect to the bracket-supporting structure to optically align the energy emitting from the temporary emitter with a predetermined second target. The second target is positioned such that optical alignment of energy emitting from the temporary emitter with the second target corresponds to an emitter retainer attitude in which, when the emitter retainer is caused to retain a permanent energy emitter, the energy emitted from the permanent energy emitter will be optically aligned with the predetermined first target. The first and second targets being one and the same represents a special case of the correspondence between the optical alignment of the temporary emitter with a second target and the optical alignment of the permanent emitter with a first target. This special case would obtain, for example, when the temporary emitter, while held in a fixed attitude by the emitter retainer, emits energy along the same optical axis that the permanent emitter emits energy when the permanent emitter replaces the temporary emitter. Although there are clear advantages to this special case resulting in co-axial correspondence between the optical axes of the temporary and permanent emitters, the method does allow for alignment of the permanent emitter with a first target by the alignment of the temporary emitter with a second target displaced with respect to the first target such that the optical axes of the temporary and permanent emitters are parallel, but not “common” or co-axial, for example. Another example of non-co-axial correspondence between the optical alignment of the temporary emitter with a second target and the optical alignment of the permanent emitter with a first target can occur when, for example, the temporary emitter emits collimated light and the permanent emitter emits non-collimated light having a known angle of divergence. For instance, a temporary emitter in the form of a visible laser could be aimed in the direction of a second target that, for the sake of illustration, is the same as the first target with which the permanent emitter is to be aligned. Since the collimated light of the laser clearly defines an optical axis, a determination can be made as to whether the target, although not “hit” by the laser beam, is nonetheless within the “divergence cone” of the permanent emitter. If the target is within the permanent emitter's divergence cone, as determined by the proximity of the laser beam to the target, then the emitter retainer is in an attitude corresponding to optical alignment between the permanent emitter and the target.

Once the temporary emitter is optically aligned with the second target as indicated, for example, by the emitted energy's striking the second target, the bracket is secured such that the attitudes of the temporary emitter and the emitter retainer are fixed with respect to the base of the energy emitter bracket. The temporary emitter is then released from the emitter retainer and the permanent emitter is installed and secured in the emitter retainer without introducing an alignment-negating net change in the attitude of the emitter retainer. Measures to ensure that no alignment-negating net change in the attitude of the emitter retainer is introduced by the removal of the temporary and installation of the permanent emitters may vary according to the particular embodiment of the emitter retainer. Illustrative alternative embodiments are discussed briefly further in this summary and more completely in the detailed description that follows.

Although optical barrier emitters and sensors are housed in housings of various configurations and dimensions, a common configuration is represented by the so-called “barrel housing.” A barrel housing, as the name suggests, is at least partially, but frequently nearly fully cylindrical. A barrel housing may contain an emitter, a sensor or, when adapted for use in a reflectance barrier system, an emitter and a sensor. A barrel housing frequently includes a set of external threads about at least a portion of its cylindrical exterior surface. In some instances, the external threads about the barrel housing are adapted for direct threading into a set of internal threads formed within a housing-retaining aperture in the emitter retainer portion of an optical barrier unit bracket (i.e., an emitter, retainer or emitter/retainer bracket). Alternatively, the barrel housing is linearly inserted into an unthreaded aperture through a wall or plate of the emitter retainer portion and secured in place by the threading of a jam nut about the threaded housing portion on either side of the wall or plate. In still additional alternative versions, the emitter retainer includes a split clamp bracket having first and second sections held together by, for example, threaded fasteners such as screws. Each of the first and second sections includes an arcuate void formed in an edge adapted to oppose the notched edge of the other section. When the notched edges of the first and second sections are brought together, the notches combine to define a housing-retaining aperture.

Representative methods and illustrative associated apparatus for executing the same are more completely described and depicted in the following detailed description and the accompanying drawings.

### BRIEF DESCRIPTION OF THE DRAWINGS

FIG. 1 depicts illustrative apparatus and a temporary emitter used in setting a permanent electromagnetic energy emitter in optical alignment with a predetermined first target to establish an optical barrier;

FIG. 2 depicts an illustrative permanent emitter in place of the temporary emitter in the environment of FIG. 1;

FIG. 3 includes illustrative method steps representative of a method of setting a permanent electromagnetic energy emitter in optical alignment with a predetermined first target;

FIG. 4 depicts the alignment apparatus shown in FIG. 1 with an alternatively configured temporary emitter;

FIG. 5A illustrates a temporary emitter retained in an emitter retainer by a jam nut;

FIG. 5B depicts a temporary emitter retained by an emitter retainer in the form of a split clamp;

FIG. 6 shows a temporary emitter optically aligned with a reflector such that the energy beam is directed back toward the source; and

FIG. 7 shows a permanent emitter/detector unit having a barrel housing in place of the temporary emitter shown in FIG. 6.

### DETAILED DESCRIPTION

The following description of various implementations and methods of optically aligning elements of an optical barrier system is illustrative in nature and is therefore not intended to limit the scope of the invention or its application of uses.

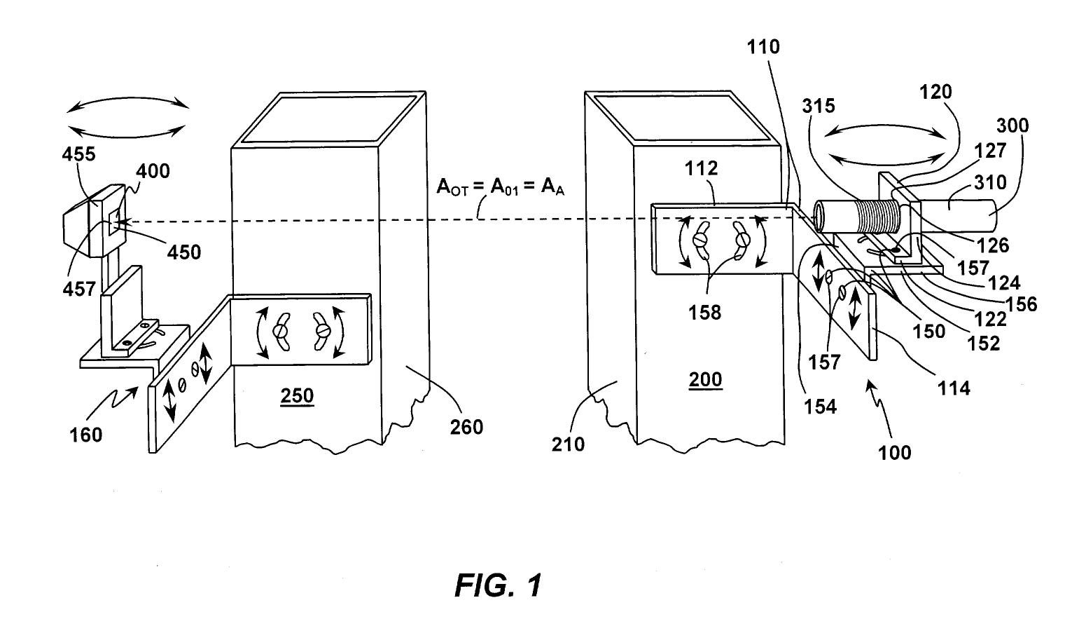

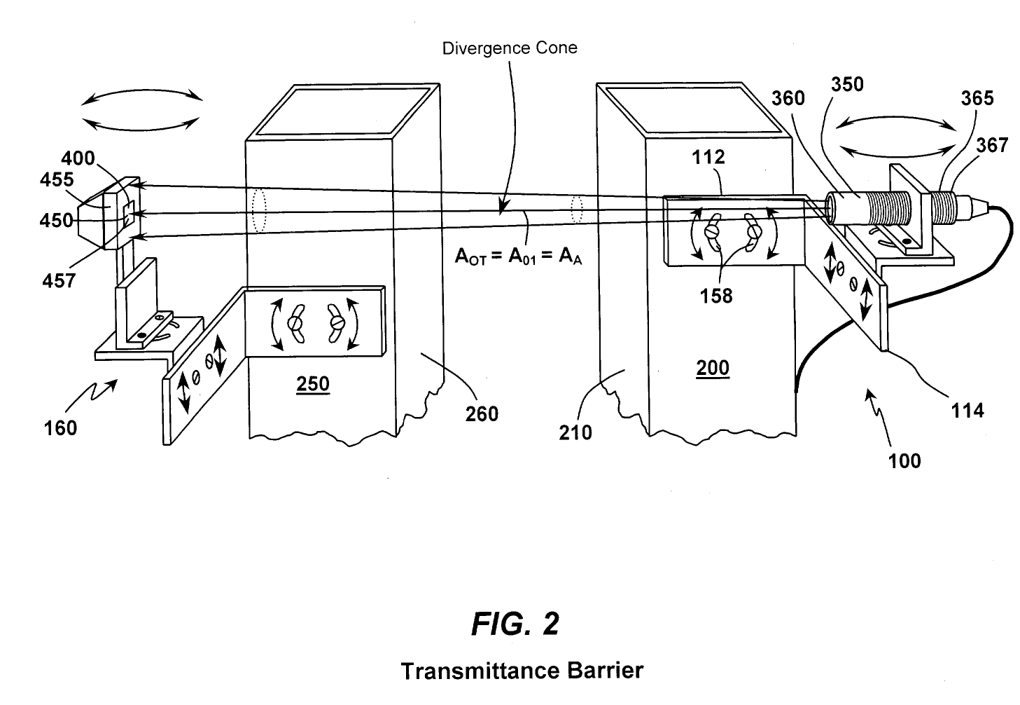

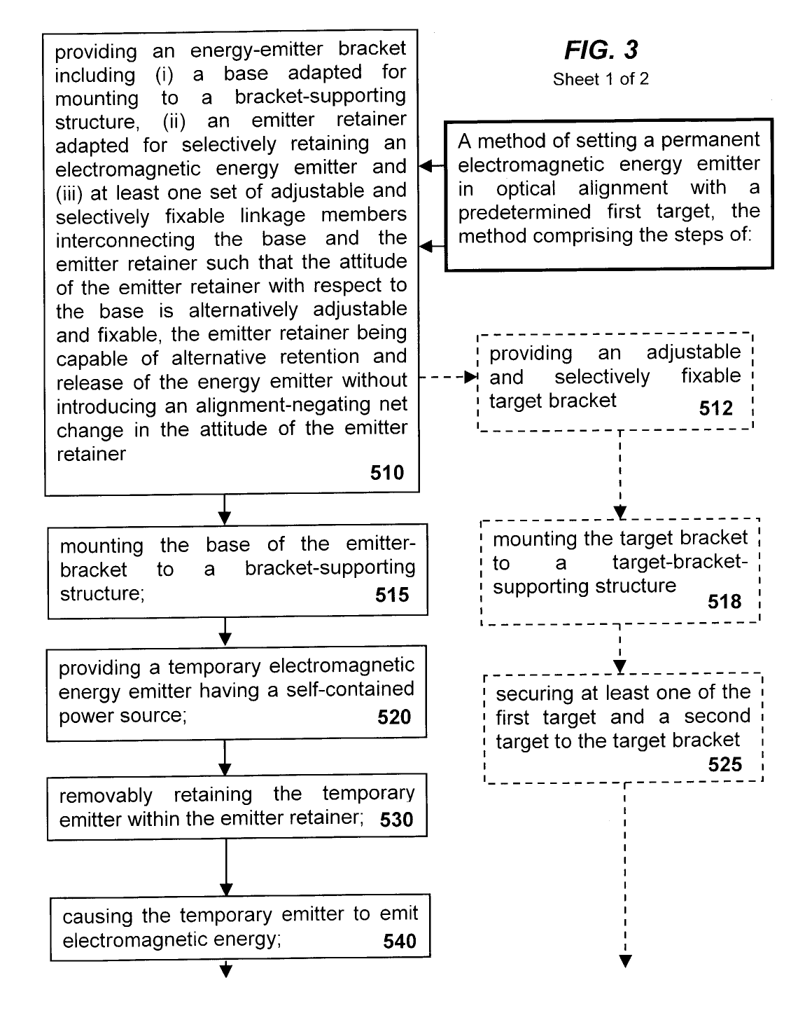

FIGS. 1 and 2 depict illustrative apparatus for implementing a method of optically aligning a permanent electromagnetic-energy emitter 350 with a first predetermined target 400 (e.g., a sensor) while FIG. 3 includes method steps of an illustrative alignment method using the apparatus of FIGS. 1 and 2. The sequence of steps presented in the drawings and described in the text are illustrative only and not necessarily indicative of the order in which the steps must be performed. Accordingly, nothing in the drawings, this description or the corresponding claims should be construed so as to limit the scope of the invention to a particular sequence of steps in the absence of explicit statements to the contrary or unless a particular order is inextricably dictated by context. Reference is made to FIGS. 1 and 2 for illustrations of apparatus discussed in connection with methods of alignment.

Referring to FIG. 3, an emitter bracket 100 is provided at step 510. The emitter bracket 100 includes (i) a base 110 adapted for mounting to a bracket-supporting structure 200 such as a column 210; (ii) an emitter retainer 120 and (iii) a set of linkage members 150 interconnecting the base 110 and the emitter retainer 120. The set of linkage members 150 is adjustable and selectively fixable such that the attitude of the emitter retainer 120 with respect to the base 110 is alternatively adjustable and fixable. Moreover, the emitter retainer 120 is adapted for alternative retention and release of an emitter without introducing an alignment-negating net change in the attitude of the emitter retainer 120.

Although a typical emitter bracket 100 includes the aforementioned three components, the particular configurations of the components and the particular combination of the components are not material. However, for the purpose of elucidation, the particular illustrative emitter bracket 100 of FIGS. 1 and 2 includes an L-shaped base 110 including a first leg 112 for securing to the bracket-supporting structure 200 and a second leg 114. An L-shaped emitter retainer 120 includes a foot 122 and a support wall 124 depending from the foot 122. The base 110 and the emitter retainer 120 are interconnected by a set of linkage members 150 including an L-shaped platform 152 having first and second plates 154 and 156 and threaded fasteners 157 for retaining the foot 112 of the emitter retainer 120 to the second plate 156 of the platform 152 and the first plate 154 of the platform 152 to the second leg 114 of the L-shaped base 110. Arcuate fastener slots 158 are provided in each of (i) the first leg 112 of the base 110 and (ii) each of the first and second plates 154 and 156 of the platform 152 to permit angular degrees of freedom as indicated between the various components of the emitter bracket 100 when the fasteners 157 are loosened.

At step 515, an individual mounts the base 110 of the emitter bracket 100 to a bracket-supporting structure 200.

At step 520, a technician or other individual executing the alignment method, provides a temporary electromagnetic energy emitter 300 having a self-contained power source (not shown) such as a battery or solar panel. A pocket or pointer laser is an example of a temporary electromagnetic energy emitter 300 that is particularly useful in implementing the alignment method. Such devices are compact, inexpensive, readily available and, when typically configured, particularly well suited to the alignment of emitters and sensors having barrel housings.

At step 530, the emitter retainer 120 is caused to removably retain the temporary emitter 300. The precise manner of retention will, of course, vary among particular implementations. In the particular implementation depicted in FIGS. 1 and 2, the support wall 124 includes an aperture 126 including a set of internal threads 127 (not shown explicitly). The temporary emitter 300 includes a housing 310 having a cylindrical portion provided with external threads 315. The external threads 315 are adapted for threading into the internal threads 127 in the support wall 124 of the emitter retainer 120.

With the temporary emitter 300 removably retained by the emitter retainer 120, the temporary emitter 300 is caused, at step 540, to emit electromagnetic energy. Preferably the emitted energy is in the visible region of the electromagnetic spectrum such that its impingement upon objects is observable with the naked eye. As previously mentioned, although the temporary emitter 300 need not be a laser, the use of a laser does facilitate implementation of the alignment method for various reasons including the collimation of the emitted energy and the ready observability of its concentrated impingement upon objects at relatively great distances from the source. Tightly collimated laser light also defines an optical axis with greater definiteness than light sources resulting in more divergent energy beams.

As energy emits from the temporary emitter 300, the emitter bracket 100 is adjusted by, for example, manipulating the base 110, platform 150 and emitter retainer 120 to achieve a desired attitude for the temporary emitter 300 in accordance with step 550. The desired attitude is realized by optically aligning the temporary emitter 300 with a second target 450, a condition evidenced by causing the impingement of the energy emitting from the temporary emitter 300 on the second target 450 and sometimes referred to as “acquiring the (second) target.” The second target 450 is positioned such that optical alignment of the temporary emitter 300 with the second target 450 corresponds to an attitude of the emitter retainer 120 in which, when the emitter retainer is caused to retain the permanent energy emitter 350, the permanent energy emitter 350 will be optically aligned with the predetermined first target 400 (i.e., energy emitted from the permanent energy emitter 350 will impinge on the first target 400). The implementations illustrated in FIGS. 1 and 2 represent a special, but by no means universal, case in which the first and second targets 400 and 450 are one and the same (i.e., the acceptance window 457 of the energy detector 455). This situation is realized when, for example, for any given fixed attitude of the emitter retainer 120, the permanent energy emitter 350 emits energy along the same optical axis A_{O1} as the temporary emitter 300.

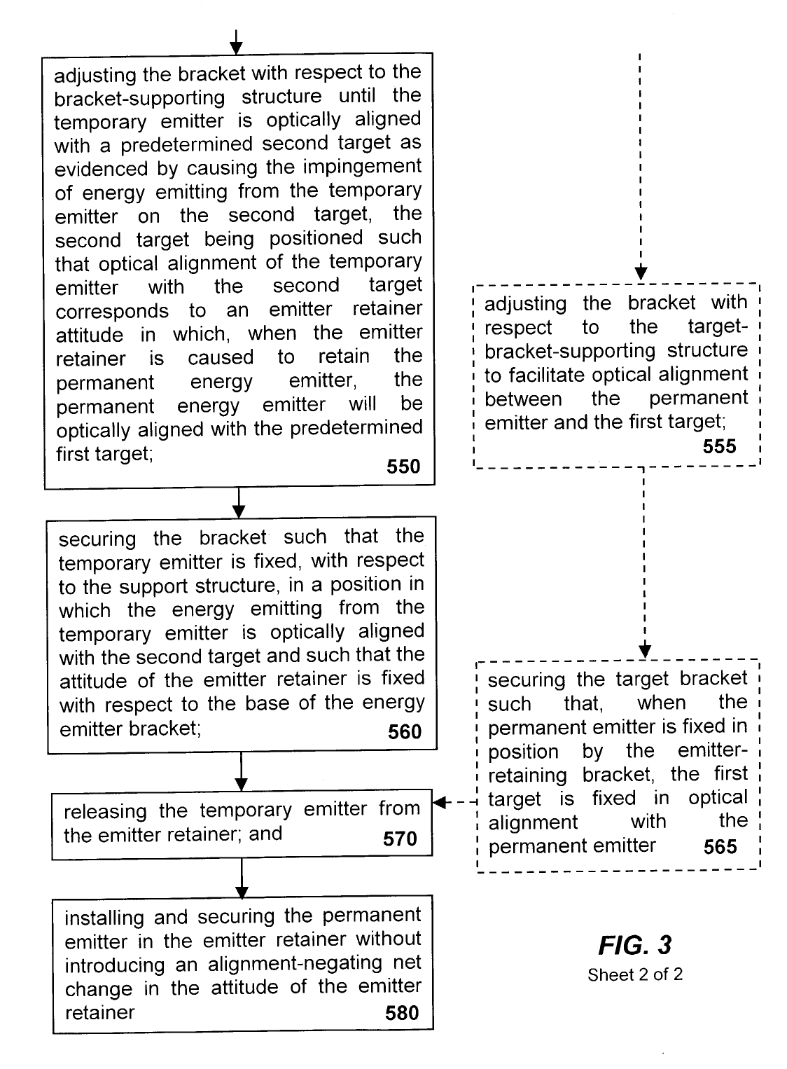

FIG. 4 depicts an illustrative set of circumstances in which the optical axes A_{O1} and A_{O1} of energy emitting from the temporary and permanent emitters 300 and 350 are distinct. In FIGS. 1 and 2, the temporary and permanent emitters 300 and 350 emit energy having an optical axis A_{O1} co-linear with the aperture axis A_{A} of the threaded aperture 126 in the support wall 124. However, the illustrative temporary emitter 300 of FIG. 4 emits energy along an optical axis A_{O1+D} parallel to, but displaced by a displacement D with respect to the aperture axis A_{A} . If D and the angular disposition of optical axis A_{O1+D} with respect to aperture axis A_{A} (as defined by a vector within a plane perpendicular to the axes A_{A} and A_{O1+D} ) are known quantities, a second target 450 can be properly situated with respect to the first target 400 such that “optical alignment of the temporary emitter 300 with the second target 450 corresponds to an attitude of the emitter retainer 120 in which, when the emitter retainer 120 is caused to retain the permanent energy emitter 350, the permanent energy emitter will be optically aligned lo with the predetermined first target 400.” In the particular illustrative situation depicted in FIG. 4, the optical axis A_{O1+D} is displaced by a distance of magnitude D at an angle of 90° with respect to a horizontal plane (not shown) that includes the aperture axis A_{A}. Provided with this information, an individual can readily ascertain whether the emitter retainer 120 is at an attitude in which, when the permanent emitter 350 is retained thereby, the permanent emitter 350 will be optically aligned with the first target 400.

In addition to the aforementioned observations, it will also be readily appreciated that “optical alignment” can be established within a more “forgiving” set of tolerances when the permanent emitter 350 emits non-collimated energy since, although the temporary emitter 300 may not impinge precisely on the second target 450, the first target may still be within the “divergence cone” of the energy that emits from the permanent emitter 350. The “alignment” determination in such cases will ultimately depend on factors such as the angle of the energy divergence cone and the distance between the permanent emitter 350 and the first target 400. Referring to FIG. 2, the illustrative permanent emitter 350 emits non-collimated energy such that the first target 400 is well within the energy divergence cone of the permanent emitter 350. The intensity of the energy within the divergence cone may vary with radius from the optical axis A_{O1}, but as a theoretical observation, one's positioning calculation during the alignment of the temporary emitter 300 could be off by an amount as large as the radius of the permanent emitter's divergence cone at a plane perpendicular to the optical axis A_{O1} positioned at the first target 400.

Once the temporary emitter 300 is optically aligned with the second target 450, the emitter bracket 100 is secured, in accordance with step 560, such that the temporary emitter 300, and the attitude of the emitter retainer 120, is fixed with respect to the support structure 200 to which the base 110 is secured.

At step 570, the temporary emitter 300 is removed from the emitter retainer 120 and, at step 580, the permanent emitter 350 is installed and secured in the emitter retainer 120 in a manner introducing no alignment-negating net change in the attitude of the emitter retainer 120. The particular permanent emitter 350 depicted in FIG. 2 includes a barrel housing 360 having an externally threaded portion 365 including external threads 367 extending along a portion of the length of the housing 360. The external threads 367 are adapted for threading into the internal threads 127 of the aperture 126 in the support wall 124.

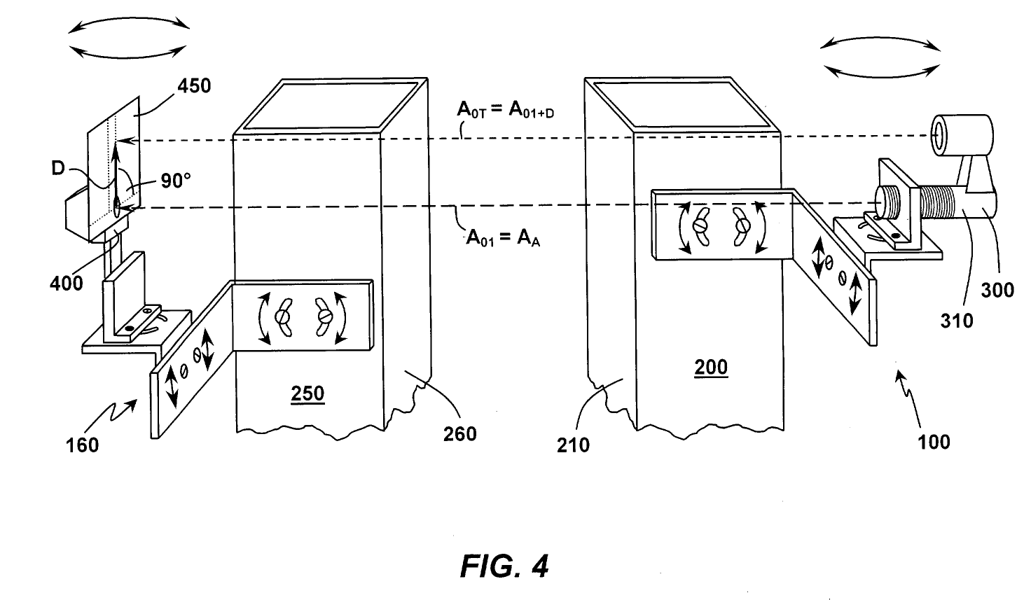

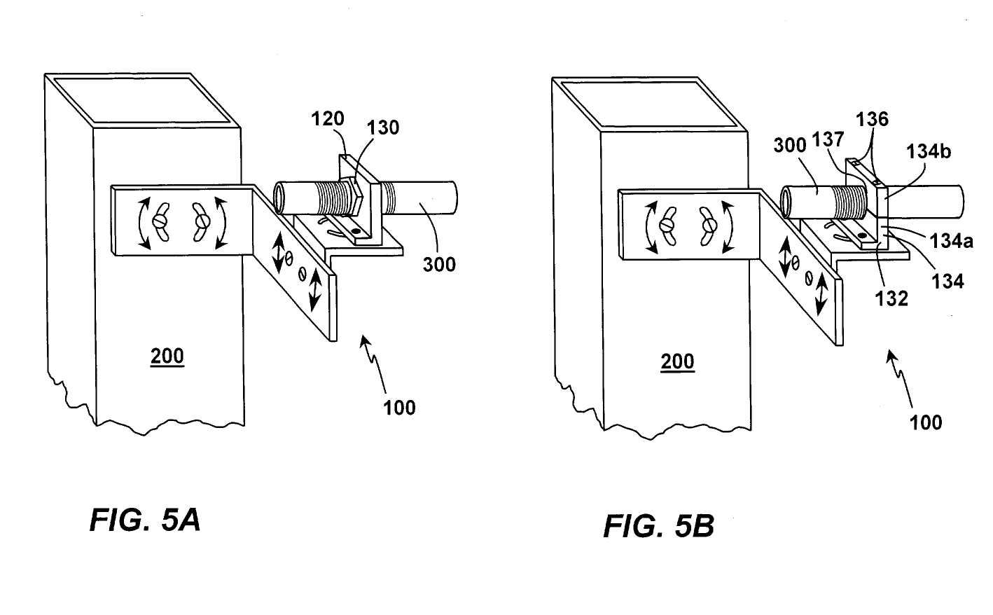

As previously discussed, alternative emitter retainers 120 retain the temporary and permanent emitters 300 and 350 in alternative ways. However, it will be readily appreciated that retention of the temporary and permanent emitters 300 and 350 by a threaded aperture 126 facilitates introducing no alignment-negating net change in the attitude of the emitter retainer 120 during that portion of the process beginning with removal of the temporary emitter 300 and ending with the installation of the permanent emitter 350. There are, or course, multitudinous alternative apparatus that would facilitate the function of replacing the temporary emitter 300 with the permanent emitter 350 in a manner that does not introduce an alignment-negating net change in the attitude of the emitter retainer 120. An illustrative, non-limiting list of such apparatus includes (i) a spring-loaded clip for alternative clamping about portions of the housings of the temporary and permanent emitters 300 and 350 having similar cross-sections and (ii) one or more threaded fasteners such as screws or bolt and nut sets for securing in alignment holes provided in both the emitter retainer 120 and each of the temporary and permanent emitters 300 and 350. As previously mentioned, one existing method of retaining a barrel sensor having a threaded housing in either a smooth-bore or threaded aperture includes the use of a jam nut threaded about the housing on at least one side of the structure through which the aperture extends. Such a retention method could be applied to the temporary and permanent emitters 300 and 350 as well. An exemplary use of a jam nut 130 to retain a temporary emitter 300 is shown in FIG. 5A. Another example of retention apparatus currently in use is the split clamp, an example of which is shown in FIG. 5B. The split clamp 132 of FIG. 5B includes a bifurcated support wall 134 having lower and upper wall portions 134a and 134b. The wall portions 134a and 134b are held together with threaded fasteners 136 and, when secured in abutting relationship, define an aperture 137. The aperture 137 may be threaded or smooth-bore and the material defining the aperture 137 adapted accordingly for at least one of threading and clamping engagement with the exterior of the housings of temporary and permanent emitters 300 and 350.

As explicitly shown in FIG. 3, as well as implied by the particular apparatus of FIGS. 1, 2 and 4, alternative methods of optically aligning a permanent energy emitter 350 with a predetermined first target 400 further include the step 512 of providing an adjustable target bracket 160. The target bracket 160 is, at step 518, mounted to a target-bracket-supporting structure 250 such as a post 260. At step 525 at least one of the first and second targets 400 and 450 is secured to the target bracket 160. In accordance with step 555, the target bracket 160 is adjusted to facilitate optical alignment of the permanent emitter 350 and the first target 400. At step 565, the adjustable target bracket 160 is secured such that, when the permanent emitter 350 is fixed in position by the emitter-retaining bracket 100, the first target 400 is fixed in optical alignment with the permanent emitter 350.

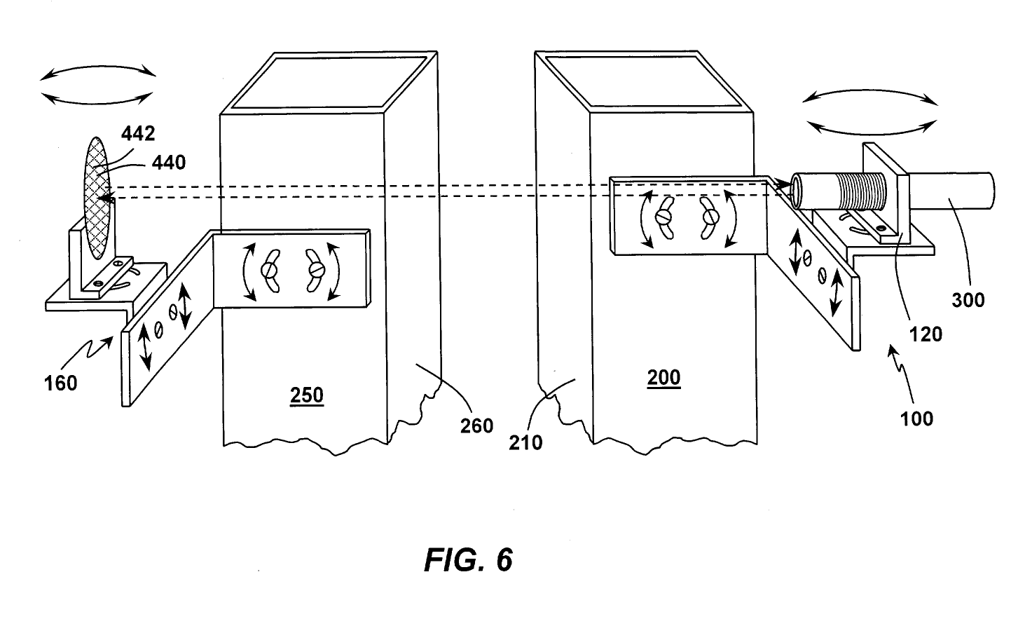

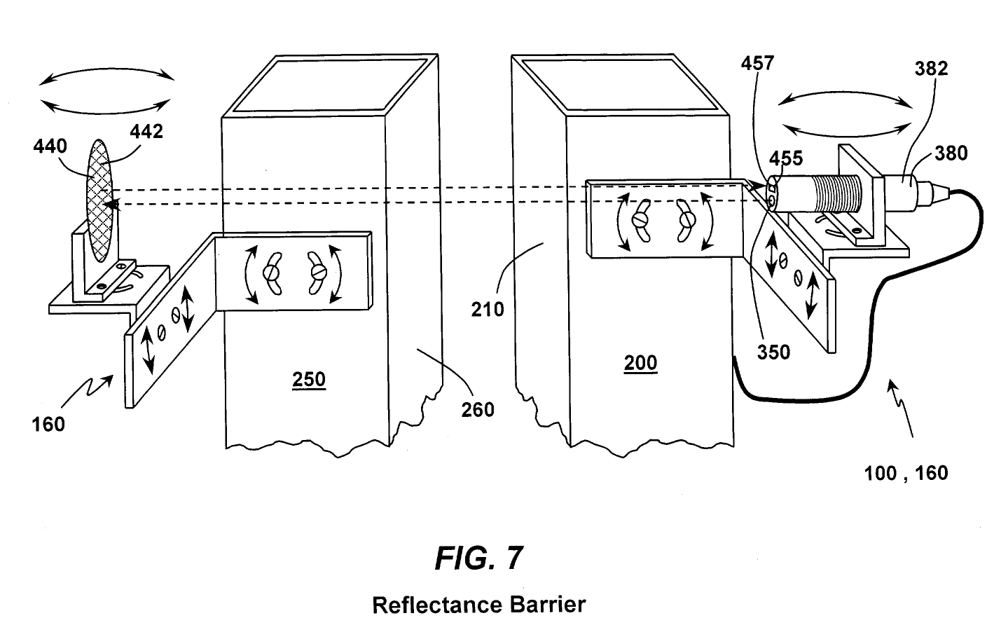

FIGS. 6 and 7 depict the optical alignment of elements of a reflectance barrier system. The reflectance barrier system of FIG. 7 includes an emitter/detector unit 380 having, in a single housing 382, both an energy emitter 350 and an energy detector 455, the detector 455 constituting the first target 400. However, as is characteristic of reflectance barriers, the energy beam emitted from the permanent emitter 350 impinges upon at least one intermediate target 440 that reflects the beam. In the particular case illustrated in FIG. 7, the emitted energy beam reflects off a single reflector element 442 that reflects the beam in an anti-parallel direction toward the source for receipt through the acceptance window 457 of the energy detector 455. Analogous to the alignment of some of the aforementioned optical barrier systems, each intermediate target 440 of a selected set of intermediate targets 440 is, in alternative implementations, secured to an adjustable and selectively fixable target bracket 160 to facilitate an alignment method using a temporary emitter 300 as shown in FIG. 6. It will be readily understood that, in the case of a reflectance barrier system in which the energy emitter 350 and the energy detector 455 are housed in a single housing such as housing 382, the emitter bracket 100 and second target bracket 160 are one and the same.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact construction, implementations and versions shown and described.

What is claimed is:

1. A method of setting a permanent electromagnetic energy emitter in optical alignment with a predetermined first target, the method comprising:
providing an adjustable energy-emitter bracket including (i) a base adapted for mounting to a bracket-supporting structure, (ii) an emitter retainer adapted for selectively retaining an electromagnetic energy emitter and (iii) at least one set of adjustable and selectively fixable linkage members interconnecting the base and the emitter retainer such that the attitude of the emitter retainer with respect to the base is alternatively adjustable and fixable, the emitter retainer being capable of alternative retention and release of an energy emitter without introducing an alignment-negating net change in the attitude of the emitter retainer;
mounting the base of the emitter bracket to a bracket-supporting structure;
providing a temporary electromagnetic energy emitter having a self-contained power source;
removably retaining the temporary emitter with the emitter retainer;
causing the temporary emitter to emit electromagnetic energy;
adjusting the bracket with respect to the bracket-supporting structure so the temporary emitter is optically aligned with a predetermined second target as evidenced by causing the impingement of energy emitting from the temporary emitter on the second target, the second target being positioned such that optical alignment of the temporary emitter with the second target corresponds to an emitter retainer attitude in which, when the emitter retainer is caused to retain the permanent energy emitter, the permanent energy emitter is optically aligned with the predetermined first target;
securing the bracket such that the temporary emitter is fixed, with respect to the support structure, in a position in which the energy emitting from the temporary emitter is optically aligned with the second target and such that the attitude of the emitter retainer is fixed with respect to the base of the energy emitter bracket;
releasing the temporary emitter from the emitter retainer; and
installing and securing the permanent emitter in the emitter retainer without introducing an alignment-negating net change in the attitude of the emitter retainer.

2. The method of claim 1 wherein the temporary emitter emits collimated electromagnetic energy.

3. The method of claim 2 wherein the collimated electromagnetic energy is laser light including at least one energy wavelength in the visible region of the electromagnetic spectrum.

4. The method of claim 1 wherein the first target is an electromagnetic energy detector and the method further comprises:
providing an adjustable and selectively fixable target bracket;
securing at least one of the first and second targets to the target bracket;
mounting the target bracket to a target-bracket-supporting structure;
adjusting the bracket with respect to the target-bracket-supporting structure to facilitate optical alignment between the permanent emitter and the first target; and
securing the target bracket such that, when the permanent emitter is fixed in position by the emitter-retaining bracket, the first target is fixed in optical alignment with the permanent emitter.

5. The method of claim 1 wherein the emitter retainer includes a support wall with an aperture therethrough having an aperture axis and including a set of internal threads and wherein each of the temporary and permanent emitters includes a housing from which depends a set of external threads adapted for threading into the internal threads of the aperture for selectively retaining that emitter.

6. The method of claim 5 wherein, when each of the temporary and permanent emitters is retained by the emitter retainer and caused to emit electromagnetic energy, that emitter emits energy along an optical axis parallel to the aperture axis.

7. The method of claim 5 wherein, for a particular emitter retainer attitude, the permanent emitter, when retained by the emitter retainer, emits energy along an optical axis parallel to an optical axis along which the temporary emitter, when retained by the emitter retainer, emits energy.

8. The method of claim 5 wherein, for a particular emitter retainer attitude, the permanent emitter, when retained by the emitter retainer, emits energy along an optical axis common to an optical axis along which the temporary emitter, when retained by the emitter retainer, emits energy.

9. A method of setting a permanent electromagnetic energy emitter in optical alignment with a predetermined first target, the method comprising:
providing an adjustable energy-emitter bracket including (i) a base adapted for mounting to a bracket-supporting structure, (ii) an emitter retainer adapted for selectively retaining an electromagnetic energy emitter and (iii) at least one set of adjustable and selectively fixable linkage members interconnecting the base and the emitter retainer such that the attitude of the emitter retainer with respect to the base is alternatively adjustable and fixable, the emitter retainer being capable of alternative retention and release of an energy emitter without introducing an alignment-negating net change in the attitude of the emitter retainer;
mounting the base of the emitter bracket to a bracket-supporting structure;
providing a temporary electromagnetic energy emitter that emits collimated laser light including at least one energy wavelength in the visible region of the electromagnetic spectrum and that has a self-contained power source;
removably retaining the temporary emitter with the emitter retainer;
causing the temporary emitter to emit electromagnetic energy;
adjusting the bracket with respect to the bracket-supporting structure so the temporary emitter is optically aligned with a predetermined second target as evidenced by causing the impingement of energy emitting from the temporary emitter on the second target, the second target being positioned such that optical alignment of the temporary emitter with the second target corresponds to an emitter retainer attitude in which, when the emitter retainer is caused to retain the permanent energy emitter, the permanent energy emitter is optically aligned with the predetermined first target;
securing the bracket such that the temporary emitter is fixed, with respect to the support structure, in a position in which the energy emitting from the temporary emitter is optically aligned with the second target and such that the attitude of the emitter retainer is fixed with respect to the base of the energy emitter bracket;
releasing the temporary emitter from the emitter retainer; and
installing and securing the permanent emitter in the emitter retainer without introducing an alignment-negating net change in the attitude of the emitter retainer.

10. The method of claim 9 wherein the first target is an electromagnetic energy detector and the method further comprises:
providing an adjustable and selectively fixable target bracket;
securing at least one of the first and second targets to the target bracket;
mounting the target bracket to a target-bracket-supporting structure;
adjusting the bracket with respect to the target-bracket-supporting structure to facilitate optical alignment between the permanent emitter and the first target; and
securing the target bracket such that, when the permanent emitter is fixed in position by the emitter-retaining bracket, the first target is fixed in optical alignment with the permanent emitter.

11. The method of claim 9 wherein the emitter retainer includes a support wall with an aperture therethrough having an aperture axis and including a set of internal threads and wherein each of the temporary and permanent emitters includes a housing from which depends a set of external threads adapted for threading into the internal threads of the aperture for selectively retaining that emitter.

12. The method of claim 11 wherein, when each of the temporary and permanent emitters is retained by the emitter retainer and caused to emit electromagnetic energy, that emitter emits energy along an optical axis parallel to the aperture axis.

13. The method of claim 11 wherein, for a particular emitter retainer attitude, the permanent emitter, when retained by the emitter retainer, emits energy along an optical axis parallel to an optical axis along which the temporary emitter, when retained by the emitter retainer, emits energy.

14. The method of claim 11 wherein, for a particular emitter retainer attitude, the permanent emitter, when retained by the emitter retainer, emits energy along an optical axis common to an optical axis along which the temporary emitter, when retained by the emitter retainer, emits energy.
